(19) United States
(12) Patent Application Publication
(10) Pub. No.: US 2018/0024670 A1
(43) Pub. Date: Jan. 25, 2018

(54) TOUCH PANEL

(71) Applicant: SHARP KABUSHIKI KAISHA, Sakai City, Osaka (JP)

(72) Inventors: ATSUSHI OKADA, Sakai City (JP); DAIJI KITAGAWA, Sakai City (JP); MASASHI MAYUMI, Sakai City (JP)

(21) Appl. No.: 15/550,011

(22) PCT Filed: Feb. 3, 2016
(86) PCT No.: PCT/JP2016/053234

§ 371 Date: Aug. 9, 2017

(30) Foreign Application Priority Data
Feb. 9, 2015 (JP) 2015-023263

(51) Int. Cl. G06F 3/044; G06F 3/041

(52) U.S. Cl. CPC G06F 3/044; G06F 3/0416

(57) ABSTRACT

A touch panel with improved accuracy for detecting a touched position is provided. A touch panel 10 includes a substrate 18; a plurality of electrodes 24A, 24B provided on the substrate 18; a control unit (controller 16) that detects a touched position on the substrate 18; and a plurality of lead-out lines 22A, 22B that electrically connect the control unit and the electrodes 24A, 24B. At least a part of the lead-out lines 22A, 22B is arranged in an area on the substrate 18 where a touched position can be detected. The control unit performs self-capacitance sensing for transmitting a signal to each of the electrodes 24A, 24B thereby detecting a touched position, and mutual capacitance sensing for transmitting a signal to a plurality of pairs of electrodes 24A, 24B, each pair being composed of two of the electrodes, thereby detecting a touched position, so as to detect a touched position based on the touched position detected by the self-capacitance sensing and the touched position detected by the mutual capacitance sensing.

### TECHNICAL FIELD

The present invention relates to a touch panel.

### BACKGROUND ART

As an input device of an information apparatus such as a smartphone or a tablet terminal, a touch panel is known widely. The touch panel is arranged, for example, so as to be stacked on a display screen of the information apparatus.

In recent years, it has been proposed to make narrower a part (a so-called frame region) surrounding the image display region in a display screen of an information apparatus. This is accompanied by a proposal of making a touched position detectable area wider also in a touch panel that is arranged so as to be stacked on a display screen of an information apparatus (see Patent Document 1).

### PRIOR ART DOCUMENT

### Patent Document

Patent Document 1: JP-A-2012-150782

### SUMMARY OF THE INVENTION

### Problem to be Solved by the Invention

It is an object of the present invention to improve accuracy in detecting a touched position on a touch panel in which at least a part of lead-out lines connected to electrodes used for detecting a touched position are arranged within a touched position detectable area.

### Means to Solve the Problem

A touch panel in one embodiment of the present invention includes: a substrate; a plurality of electrodes provided on the substrate; a control unit that detects a touched position on the substrate; and a plurality of lead-out lines that electrically connect the control unit and the electrodes, wherein at least a part of the lead-out lines is arranged in an area on the substrate where a touched position can be detected, and the control unit performs self-capacitance sensing for transmitting a signal to each of the electrodes thereby detecting a touched position, and mutual capacitance sensing for transmitting a signal to a plurality of pairs of electrodes, each pair being composed of two of the electrodes, thereby detecting a touched position, so as to detect a touched position based on the touched position detected by the self-capacitance sensing and the touched position detected by the mutual capacitance sensing.

### Effect of the Invention

According to the present application disclosure, a touched position is detected based on a touched position detected by self-capacitance sensing, and a touched position detected by mutual capacitance sensing. This makes it possible to improve the accuracy in detecting a touched position.

### BRIEF DESCRIPTION OF DRAWINGS

FIG. 1 is a plan view illustrating a schematic configuration of a touch panel according to one embodiment of the present invention.

FIG. 2 is a block diagram illustrating a schematic configuration of a controller that the touch panel illustrated in FIG. 1 includes.

FIG. 3A illustrates signal flow in a case where mutual capacitance sensing is performed.

FIG. 3B illustrates signal flow in a case where self-capacitance sensing is performed.

FIG. 4 is an enlarged schematic diagram illustrating three electrode pairs arranged in the same column.

FIG. 5A illustrates the amounts of change in the charges in a touched area, and the amounts of change in the charges caused by noise.

FIG. 5B illustrates the amounts of change in the charges in a touched area, and the amounts of change in the charges caused by noise, in a case where a position farther from the pad as compared with the case of FIG. 5A is touched.

FIG. 6 is a flowchart illustrating a procedure for detecting a touched position.

FIG. 7A illustrates touched positions.

FIG. 7B illustrates amounts of change in the charges detected by mutual capacitance sensing in respective areas, in a case where the areas surrounded by solid lines in FIG. 7A are touched.

FIG. 8A illustrates touched positions.

FIG. 8B illustrates amounts of change in the charges detected by self-capacitance sensing in respective areas, in a case where the areas surrounded by solid lines in FIG. 8A are touched.

### MODE FOR CARRYING OUT THE INVENTION

A touch panel in one embodiment of the present invention includes: a substrate; a plurality of electrodes provided on the substrate; a control unit that detects a touched position on the substrate; and a plurality of lead-out lines that electrically connect the control unit and the electrodes, wherein at least a part of the lead-out lines is arranged in an area on the substrate where a touched position can be detected, and the control unit performs self-capacitance sensing for transmitting a signal to each of the electrodes thereby detecting a touched position, and mutual capacitance sensing for transmitting a signal to a plurality of pairs of electrodes, each pair being composed of two of the electrodes, thereby detecting a touched position, so as to detect a touched position based on the touched position detected by the self-capacitance sensing and the touched position detected by the mutual capacitance sensing (the first configuration).

With the first configuration, the touched position detected due to noise can be removed. This makes it possible to improve the accuracy in detecting a touched position.

In the first configuration, the control unit detects the touched position, by removing, among the touched positions detected by the mutual capacitance sensing, a touched position that does not coincide with the touched position detected by the self-capacitance sensing (the second configuration).

With the second configuration, based on the results of detection by the self-capacitance sensing that does not detect charges accumulated in an electrostatic capacitor between an electrode concerned and another electrode, a touched position detected due to noise, among touched positions detected by the mutual capacitance sensing, can be removed.

The first or second configuration further includes a terminal unit that is electrically connected with the lead-out lines and the control unit, and is arranged closer to one of ends in the predetermined direction on the substrate than the electrodes are. Regarding the widths of the lead-out lines, the lead-out line connected with the electrode arranged at a position farther from the terminal unit has a greater width (the third configuration).

The third configuration makes it possible to improve the accuracy in detecting a touched position, even in a configuration in which, when a touched position is detected by the mutual capacitance sensing, the amount of change in the charges due to noise tends to be detected at an electrode located at a position farther from the terminal unit as compared with the electrode at the touched position.

In any one of the first to third configurations, the control unit includes a circuit for performing the self-capacitance sensing, and performs the mutual capacitance sensing by using the circuit (the fourth configuration).

According to the fourth configuration, it is not necessary to prepare respective circuits for performing the self-capacitance sensing and the mutual capacitance sensing. This therefore makes it possible to reduce costs for producing the touch panel.

### Embodiment

The following describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, the dimension ratios of the constituent members illustrated in the drawings do not necessarily indicate the real dimension ratios.

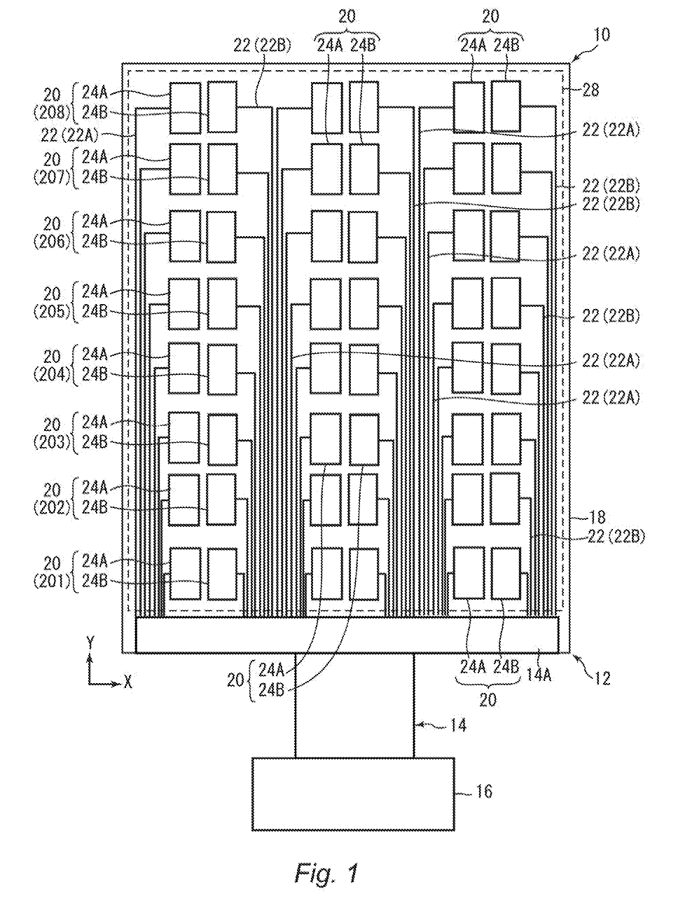

FIG. 1 is a plan view illustrating a schematic configuration of a touch panel 10 according to one embodiment of the present invention. The touch panel 10 is arranged, for example, so as to be stacked on a display region that a display device has.

According to FIG. 1, the touch panel 10 includes a touch panel main body 12, flexible printed circuits (FPC) 14, and a controller 16. The touch panel main body 12 includes a substrate 18, a plurality of electrodes 24A, 24B, and a plurality of lead-out lines 22.

The substrate 18 is made of a material that allows visible light to pass therethrough. The substrate 18 is, for example, a glass substrate. In the example illustrated in FIG. 1, the substrate 18 has a rectangular shape.

The electrodes 24A, 24B are formed on the substrate 18, and are arranged in matrix. One electrode 24A and one electrode 24B adjacent in the X direction (row direction) are paired, and an electrode pair 20 is thus formed. In the example illustrated in FIG. 1, one electrode pair group is formed with eight electrode pairs 201 to 208 arrayed in one column. In other words, in the present embodiment, three electrode pair groups are arranged.

The electrode 24B is arranged adjacent to the electrode 24A in the X direction. The electrode 24B is arranged at the same position in the Y direction (column direction) as the electrode 24A. The electrode 24A and the electrode 24B are formed in the same layer.

The electrodes 24A and the electrodes 24B are identical in size and shape. In the example illustrated in FIG. 1, the electrode 24A and the electrode 24B have a rectangular shape.

In two of the electrode pairs 20 that are adjacent in the Y direction, the electrodes 24A and the electrodes 24B are arranged at the same positions in the X direction, respectively. In the two of the electrode pairs 20 adjacent in the X direction, the electrodes 24A and the electrodes 24B are alternately arranged in the X direction.

The electrodes 24A and the electrodes 24B are formed with transparent conductive films. The transparent conductive films are, for example, indium tin oxide films.

A plurality of lead-out lines 22 are electrically connected to the plurality of electrode pairs 20, respectively. The lead-out lines 22 may be formed in the same layer as the electrodes 24A and the electrodes 24B, or may be formed in a layer different from the layer where the electrodes 24A and the electrodes 24B are formed. In the present embodiment, the lead-out lines 22 are formed in the same layer as the layer where the electrodes 24A and the electrodes 24B are formed. The lead-out lines 22 may be made of the same material as that for the electrodes 24A and the electrodes 24B, or may be formed with a material different from that for the electrodes 24A and the electrodes 24B. For example, in a case where the lead-out lines 22 are arranged at positions that overlap the black matrix formed in the display region, the lead-out lines 22 may be formed with metal films.

The lead-out lines 22 include lead-out lines 22A connected to the electrodes 24A, and lead-out lines 22B connected to the electrodes 24B. The lead-out line 22A has a portion that extends in the Y direction. At an end of the lead-out line 22A, a terminal connected to the FPC 14 is formed. The lead-out line 22B has a portion that extends in the Y direction. At an end of the lead-out line 22B, a terminal connected to the FPC 14 is formed. The terminals of the lead-out lines 22A, 22B are gathered in the vicinity of one of a pair of sides positioned away in the Y direction, among the four sides of the substrate 18 (the lower side in FIG. 1).

At least a part of the plurality of lead-out lines 22 are arranged in an area 28 in the touch panel 10 where a touched position can be detected. In the example illustrated in FIG. 1, most of the lead-out lines 22 are arranged in an area 28 where a touched position can be detected. The area 28 overlaps the display region that the display device has when the touch panel main body 12 is arranged so as to be stacked on the display device that is used together with the touch panel 10.

The FPC 14 connects the touch panel main body 12 and the controller 16 to each other. The FPC 14 includes a pad 14A as a terminal unit. The pad 14A is electrically connected to terminals of the lead-out lines 22A, 22B.

The controller 16 is electrically connected to the lead-out lines 22 through the FPC 14. The controller 16 as a control unit detects a touched position on the touch panel 10 in a manner to be described below.

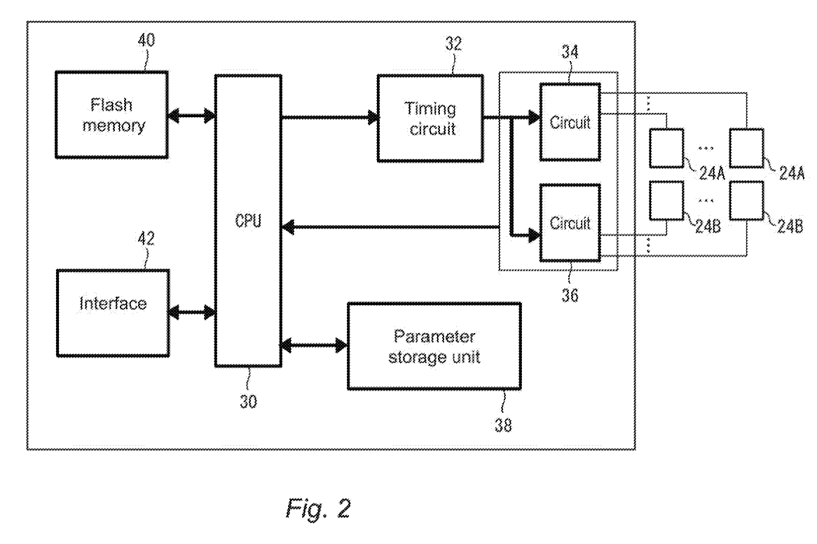

The following describes the controller 16 while referring to FIG. 2. The controller 16 includes a CPU 30, a timing circuit 32, a circuit 34, a circuit 36, a parameter storage unit 38, a flash memory 40, and an interface 42.

The CPU 30 controls operations of the touch panel main body 12. The CPU 30 reads a program stored in the flash memory 40, and based on this program, the CPU 30 executes various types of processing operations.

In a case where mutual capacitance sensing to be described below is performed, the timing circuit 32 outputs a timing signal to the circuit 34, and in a case where self-capacitance sensing to be described below is performed, the timing circuit 32 outputs a timing signal to the circuit 34 and the circuit 36. The timing signal is output at a predetermined period.

The circuit 34 and the circuit 36 perform a processing operation according to the mutual capacitance sensing or the self-capacitance sensing. Details about the mutual capacitance sensing and the self-capacitance sensing are to be described below. Each of the circuit 34 and the circuit 36 includes an A/D conversion circuit.

The parameter storage unit 38 stores a calibration parameter.

In the present embodiment, the calibration parameter is used for calibrating the amount of change in the charges, which is detected by the circuit 36, in the case of the mutual capacitance sensing, and is used for calibrating the amount of change in the charges, which is detected by the circuit 34 and the circuit 36, in the case of the self-capacitance sensing, so that the amount of change in the charges should fall in such a range that the amount can be subjected to subsequent processing operations.

The interface 42 connects the display device used together with the touch panel 10, and the controller 16 with each other.

As a method for detecting a touched position on the touch panel, the mutual capacitance sensing and the self-capacitance sensing are known. In the touch panel 10 in the present embodiment, the two methods of the mutual capacitance sensing and the self-capacitance sensing are used in order to detect a touched position with high accuracy.

First of all, the following describes the mutual capacitance sensing. In the mutual capacitance sensing, a signal for detecting a touched position is transmitted to the electrode 24A that composes the electrode pair 20, and a signal is received from the compose electrode 24B, which composes the electrode pair 20 together with the electrode 24A, whereby the touched position is detected.

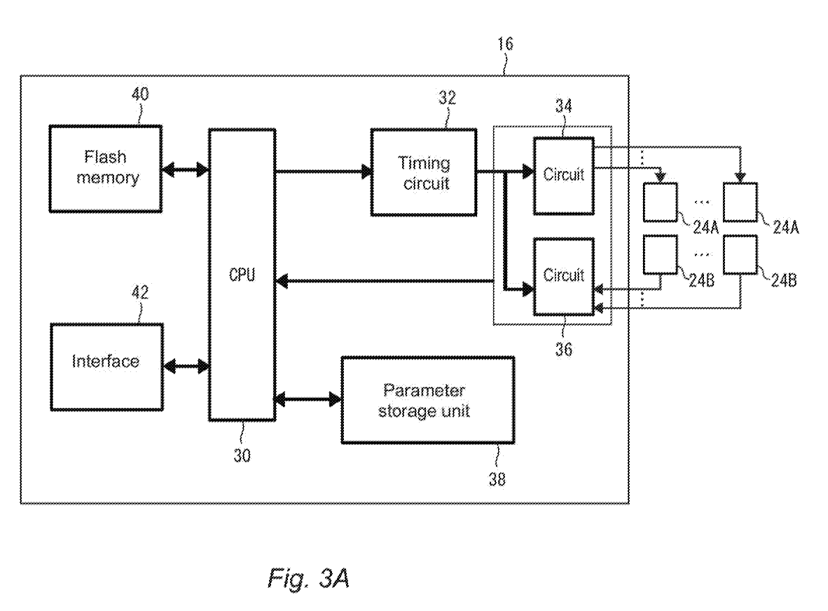

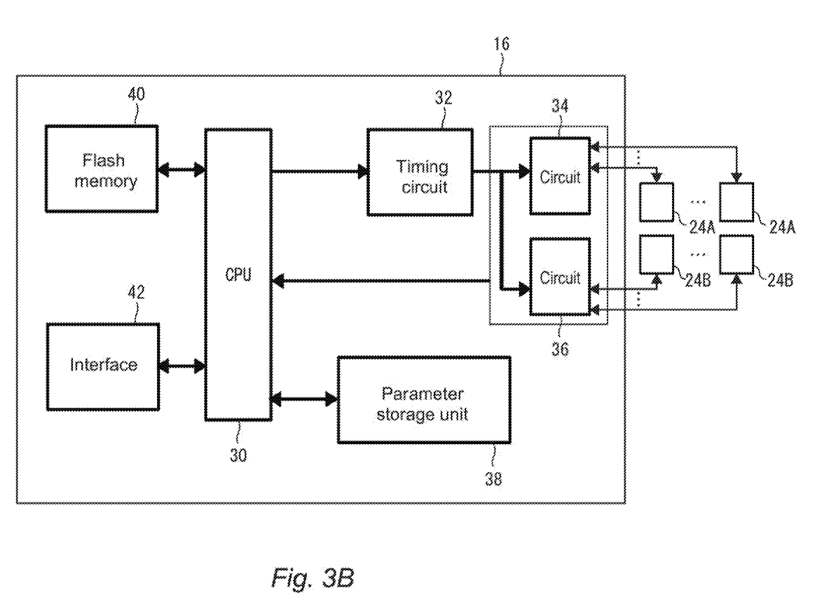

FIG. 3A illustrates signal flow in a case where the mutual capacitance sensing is performed. The timing circuit 32 outputs a timing signal to the circuit 34 and the circuit 36. Receiving the timing signal, the circuit 34 outputs a signal for detecting a touched position to the electrodes 24A through the lead-out lines 22A.

The output of the signal to the electrode 24A causes an electric field to occur between the electrode 24A and the electrode 24B. This causes charges to be accumulated in the electric capacitor formed between the electrode 24A and the electrode 24B. When any area in the area 28 is touched, the amount of charges accumulated in an electrostatic capacitor that the electrode pair 20 positioned at the touched area has (an electrostatic capacitor formed between the electrode 24A and the electrode 24B) changes. The circuit 36 receives the signal from the electrode 24B through the lead-out line 22B after receiving the timing signal from the timing circuit 32, thereby detecting this change in the amount of the charges. The change in the amount of the charges thus detected is calibrated with use of the calibration parameter. In a case where the calibrated change in the amount of charges exceeds a predetermined threshold value, the CPU 30 decides that the electrode pair 20 concerned is the electrode pair 20 at the touched position.

The following describes the self-capacitance sensing. In the self-capacitance sensing, a signal for detecting a touched position is transmitted to each of the electrodes 24A and the electrodes 24B, and a signal is received from each of the electrodes 24A, 24B, whereby a touched position is detected. In the mutual capacitance sensing, a touched position can be detected only in units of electrode pairs, but in the self-capacitance sensing, a touched position can be detected in units of electrodes.

FIG. 3B illustrates signal flow in a case where the self-capacitance sensing is performed. As is clear from FIGS. 3A and 3B, in the touch panel 10 in the present embodiment, the self-capacitance sensing is performed by using the same circuit as that used when the mutual capacitance sensing is performed.

The timing circuit 32 outputs a timing signal to the circuit 34 and the circuit 36. When receiving the timing signal, the circuit 34 outputs a signal for detecting a touched position to the electrode 24A through the lead-out line 22A. When receiving the timing signal, the circuit 36 outputs a signal for detecting a touched position to the electrode 24B through the lead-out line 22B.

When any area in the area 28 is touched, the electrostatic capacitance in the electrode 24A and/or the electrode 24B positioned in the touched area increases. In a case where the electrostatic capacitance of the electrode 24A increases, the circuit 34 detects the amount of increase in the electrostatic capacitance of the electrode 24A positioned at the touched area. Further, in a case where the electrostatic capacitance of the electrode 24B increases, the circuit 36 detects the amount of increase in the electrostatic capacitance of the electrode 24B positioned at the touched area.

The detected amount of increase in the electrostatic capacitance is calibrated with the calibration parameter. In a case where the calibrated amount of increase in the electrostatic capacitance exceeds a predetermined threshold value, the CPU 30 decides that the electrodes 24A, 24B concerned are the electrodes 24A, 24B at the touched position.

In the present embodiment, the resolution of the A/D conversion circuit that the circuit 36 includes is higher than that of the A/D conversion circuit that the circuit 34 includes. In a case where the self-capacitance sensing is performed, however, the A/D conversion circuit of the circuit 36 performs the A/D conversion at the same resolution as that of the A/D conversion circuit of the circuit 34. As compared with the resolution of the A/D conversion in the mutual capacitance sensing, therefore, the resolution of the A/D conversion in the self-capacitance sensing is lower. As compared with the self-capacitance sensing, therefore, a touched position can be detected with high accuracy in the mutual capacitance sensing.

Here, the line lengths of the lead-out lines 22A, 22B connected to the electrodes 24A, 24B, respectively, are greater as the electrodes 24A, 24B are farther from the pad 14A. If, therefore, all the lead-out lines 22 have the same line width, there is a risk that delay would occur to signal transmission to the electrodes 24A, 24B farther from the pad 14A. It is therefore preferable that the lead-out lines 22A, 22B connected to the electrodes 24A, 24B arranged at positions farther from the pad 14A have greater line widths. In the touch panel 10 in the present embodiment, the lead-out lines 22A, 22B connected to the electrodes 24A, 24B arranged at positions farther from the pad 14A have greater line widths.

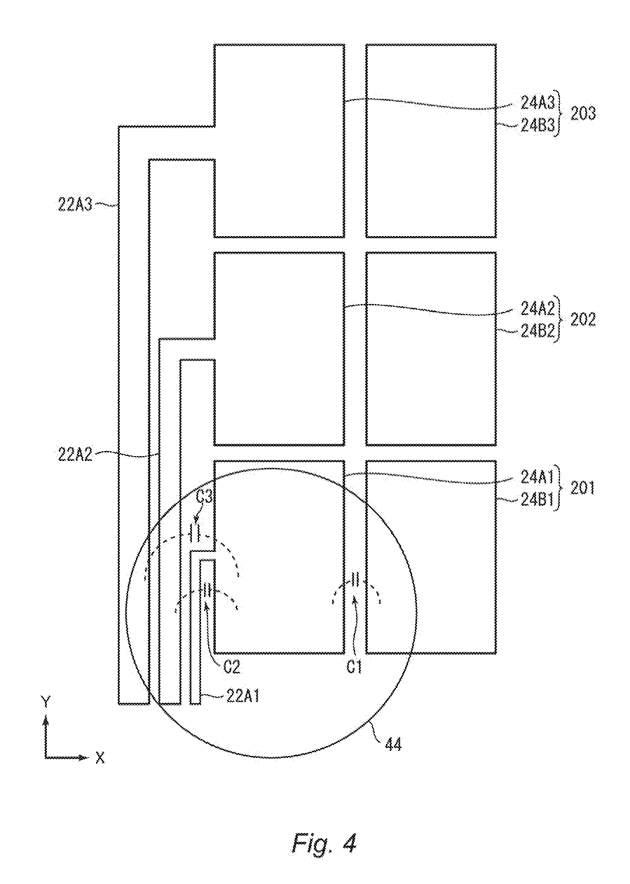

FIG. 4 is an enlarged schematic diagram illustrating three electrode pairs 201 to 203 arranged in the same column. Among the three electrode pairs 201 to 203, the electrode pair 203 is arranged at the position farthest from the pad 14A, and the electrode pair 201 is arranged at the position closest to the pad 14A.

As illustrated in FIG. 4, the line width of the lead-out line 22A3 connected to the drive electrode 24A3 that the electrode pair 203 includes is greater than the line width of the lead-out line 22A2 connected to the drive electrode 24A2 that the electrode pair 202 includes. The line width of the lead-out line 22A2 is greater than the line width of the lead-out line 22A1 connected to the drive electrode 24A1 that the electrode pair 201 includes.

Here, in the mutual capacitance sensing, in the detection of the amount of change in the charges by the circuit 36, the amount of change in the charges caused by noise is detected in some cases. The reason for this is described below.

The touched area 44 surrounded with a circle in FIG. 4 is an area touched by, for example, a human finger or the like. In the example illustrated in FIG. 4, the touch area 44 overlaps the electrode pair 201. In this case, the capacitance of the electrostatic capacitor C1 that the electrode pair 201 has changes. This leads to a change in the amount of charges accumulated in the electrostatic capacitor C1. As a result, the position of the electrode pair 201 is detected as coordinates of the touched position.

In the example illustrated in FIG. 4, the lead-out line 22A2 and the lead-out line 22A3 are arranged in the vicinity of the drive electrode 24A1. The touch area 44 therefore overlaps the lead-out line 22A2 and lead-out line 22A3 as well. Here, capacitive coupling C2 occurs between the drive electrode 24A1 and the lead-out line 22A2, and capacitive coupling C3 occurs between the drive electrode 24A1 and the lead-out line 22A3. Influenced by the capacitive coupling C2 and C3, the amounts of charges accumulated in the electrostatic capacitors that the electrode pairs 202 and 203 have change. These amounts of change in the charges detected at the electrode pairs 202, 203 are not caused by a touch at the positions of the electrode pairs 202, 203, but is caused by noise.

In other words, in the mutual capacitance sensing, in the electrode pair 20 arranged at a position farther from the pad 14A than the electrode pair 20 at the touched position in the Y direction, the amount of change in the charges caused by noise tends to be detected. For example, in FIG. 1, in a case where the electrode pair 201 is touched, the amount of change in the charges caused by noise tends to be detected at the electrode pairs 202 to 208. Further, in a case where the electrode pair 205 is touched, the amount of change in the charges caused by noise tends to be detected at the electrode pairs 206 to 208.

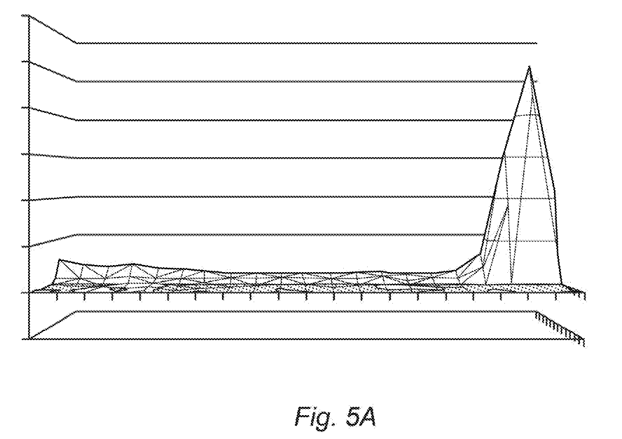

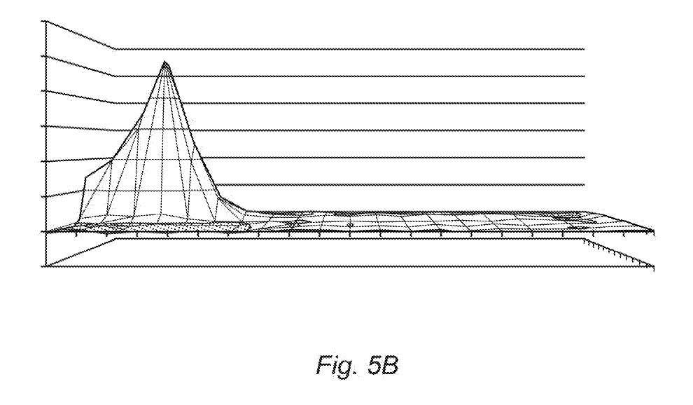

FIGS. 5A and 5B illustrate the amounts of change in the charges in a case where a part of area in the area 28 illustrated in FIG. 1 is touched. In FIGS. 5A and 5B, the coordinates on the X axis and the Y axis indicate the position of the electrode pair 20, and the coordinate on the Z axis indicates the amount of change in the charges accumulated in the electrostatic capacitor that the electrode pair 20 has. In FIGS. 5A and 5B, the part surrounded by the solid line indicates the amount of change in the charges in the touched area, and the part surrounded by the broken line indicates the amount of change in the charges caused by noise.

The amount of change in the charges caused by noise, illustrated in FIG. 5B, is greater than the amount of change in the charges caused by noise, illustrated in FIG. 5A. The reason for this is as follows.

As illustrated in FIG. 4, the lead-out line 22A is wider as the drive electrode 24A connected to the lead-out line 22A is farther from the pad 14A. As the line width increases, the capacitive coupling increases. As the capacitive coupling increases, noise is greater. The touched position illustrated in FIG. 5B is farther from the pad 14A than the touched position illustrated in FIG. 5A is. The amount of change in the charges caused by noise illustrated in FIG. 5B, therefore, is greater than the amount of change in the charges caused by noise illustrated in FIG. 5A is.

As illustrated in FIGS. 5A and 5B, the amount of change in the charges at the touched electrode pair 20 is greater than the amount of change in the charges caused by noise. It is therefore possible to detect the coordinates of the touched position even in a case where the amount of change in the charges caused by noise is detected in the mutual capacitance sensing. As well known, however, a touch panel is vulnerable to noise from outside. Noise from outside is, for example, noise from a display device used together with the touch panel. When change is caused by noise to the amount of charges and further noise from outside is added, possibly this adversely affects the detection of coordinates of a touched position. In a touch panel, therefore, preferably the amount of change in the charges caused by noise is removed in detecting the coordinates of touched positions.

It should be noted that in the self-capacitance sensing, charges accumulated in an electrostatic capacitor between the electrode concerned and another electrode are not detected, and hence the amount of change in the charges caused by noise as described above is by no means detected.

In the touch panel 10 in the present embodiment, based on touched positions detected by the mutual capacitance sensing and touched positions detected by the self-capacitance sensing, touched positions detected due to noise are removed, whereby coordinates of the touched position is detected. This method is described in detail below.

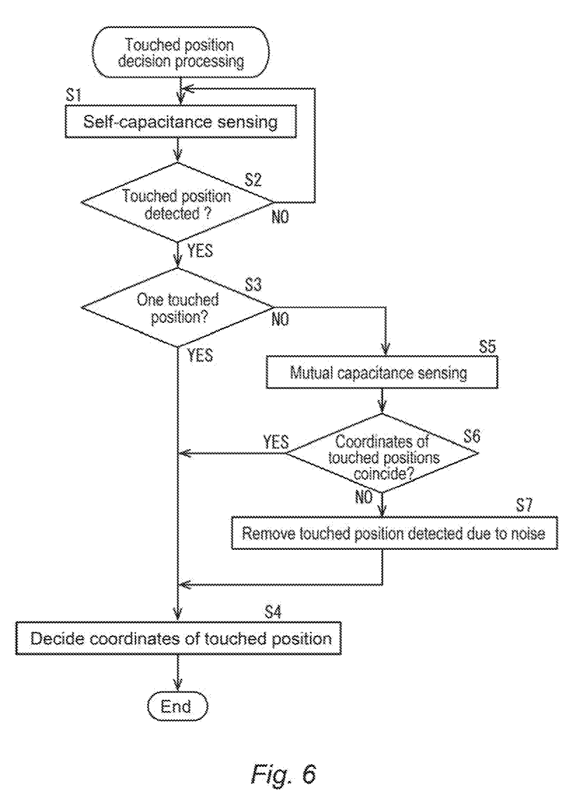

FIG. 6 is a flowchart illustrating a procedure for detecting a touched position. The CPU 30 executes a processing operation starting with step S1, at a predetermined period.

At step S1, the CPU 30 performs the self-capacitance sensing. More specifically, the CPU 30 outputs, to the timing circuit 32, an output instruction for outputting a timing signal for the circuit 34 and the circuit 36. The timing circuit 32, receiving this output instruction, outputs a timing signal to the circuit 34 and the circuit 36. After this, the CPU 30 detects the electrodes 24A, 24B positioned at a touched area by the above-described method.

At step S2, the CPU 30 determines whether or not any touched position was detected by the self-capacitance sensing performed at step S1. Here, in a case where at least one electrode among the plurality of electrodes 24A and the electrode 24B is decided to be an electrode positioned at the touched area, it is determined that one touched position is detected. When determining that a touched position has not been detected, the CPU 30 performs the processing operation of step S1 again, and when determining that a touched position is detected, the CPU 30 performs a processing operation of step S3.

At step S3, the CPU 30 determines whether or not the detected touched position is one. When determining that the detected touched position is one in number, the CPU 30 performs a processing operation of step S4. On the other hand, when determining that two or more touched positions are detected, the CPU 30 performs a processing operation of step S5.

At step S5, the CPU 30 performs the mutual capacitance sensing. More specifically, the CPU 30 outputs, to the timing circuit 32, an output instruction for outputting a timing signal for the circuit 34. The timing circuit 32, receiving this output instruction, outputs the timing signal to the circuit 34. After this, the CPU 30 detects an electrode pair 20 positioned at the touched area by the above-described method.

At step S6, the CPU 30 determines whether or not the coordinates of the touched positions detected by the self-capacitance sensing performed at step S1, and the coordinates of the touched positions detected by the mutual capacitance sensing performed at step S5, coincide with each other. Here, in a case where the electrodes 24A, 24B positioned at the touched area detected by the self-capacitance sensing, and the electrode pair 20 positioned at the touched area detected by the mutual capacitance sensing are identical to each other, it is determined that the coordinates of the touched positions detected by the self-capacitance sensing, and the coordinates of the touched positions detected by the mutual capacitance sensing, coincide with each other. For example, in FIG. 1, in a case where the electrodes 24A, 24B positioned on the lower left side are detected as the electrodes positioned at the touched area by the self-capacitance sensing, and the electrode pair 201 positioned on the lower left side is detected as an electrode pair positioned at the touched area by the mutual capacitance sensing, it is determined that the coordinates of the touched positions detected by the self-capacitance sensing and the coordinates of the touched positions detected by the mutual capacitance sensing coincide with each other.

When determining that the coordinates of the touched positions detected in the self-capacitance sensing, and the coordinates of the touched positions detected in the mutual capacitance sensing, coincide with each other, the CPU 30 performs the processing operation of step S4. On the other hand, when determining that the coordinates of the touched positions detected in the self-capacitance sensing, and the coordinates of the touched positions detected in the mutual capacitance sensing, do not coincide, the CPU 30 performs the processing operation of step S7.

At step S7, the CPU 30 determines that the touched positions detected in the mutual capacitance sensing, that do not coincide with the touched positions detected in the self-capacitance sensing, are detected as such due to changes in the charges caused by noise, and the CPU 30 removes these touched positions. In other words, among the touched positions detected in the mutual capacitance sensing, the touched positions that do not coincide with the touched positions detected in the self-capacitance sensing, are determined to be touched positions detected as being affected by noise, and are removed from the touched position determination. After performing the processing operation of step S7, the CPU 30 performs the processing operation of step S4.

At step S4, the CPU 30 decides that the coordinates of the detected touched positions indicate the touched positions of the touch panel 10. More specifically, in a case where the result of the determination at step S3 is affirmative, the coordinates of the touched positions detected in the self-capacitance sensing are recognized as the touched positions. Further, in a case where the result of the determination at step S6 is affirmative, the coordinates of the touched positions detected in the self-capacitance sensing and the mutual capacitance sensing (the coordinates that coincide) are recognized as the touched positions. Further, in a case where the processing operation of step S7 is performed, among the coordinates of the touched positions detected in the mutual capacitance sensing, the coordinates of the touched positions from which the touched positions detected due to noise are removed are determined to be the touched positions.

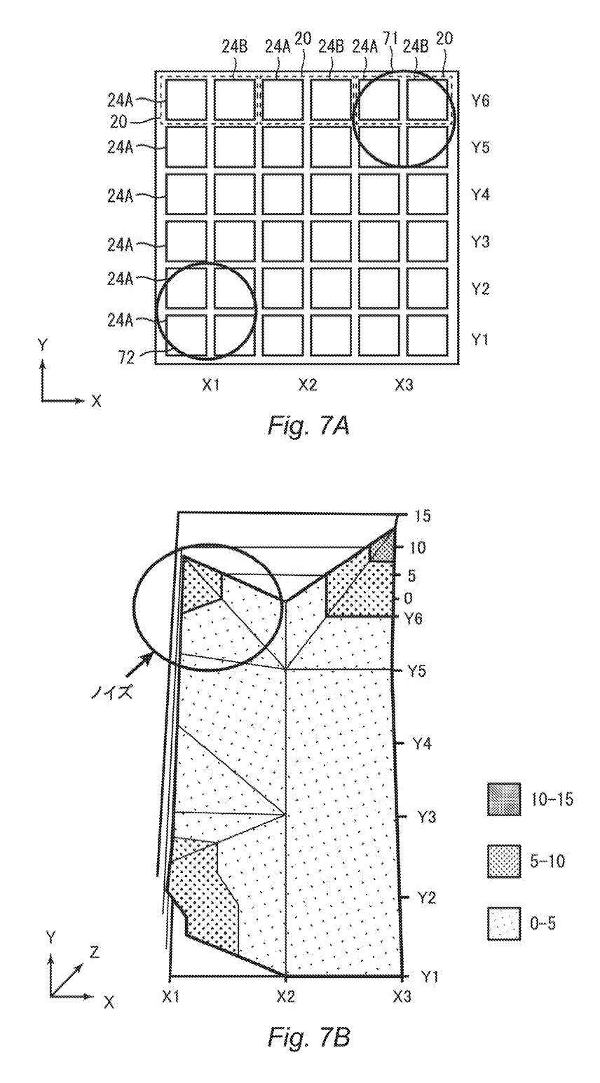

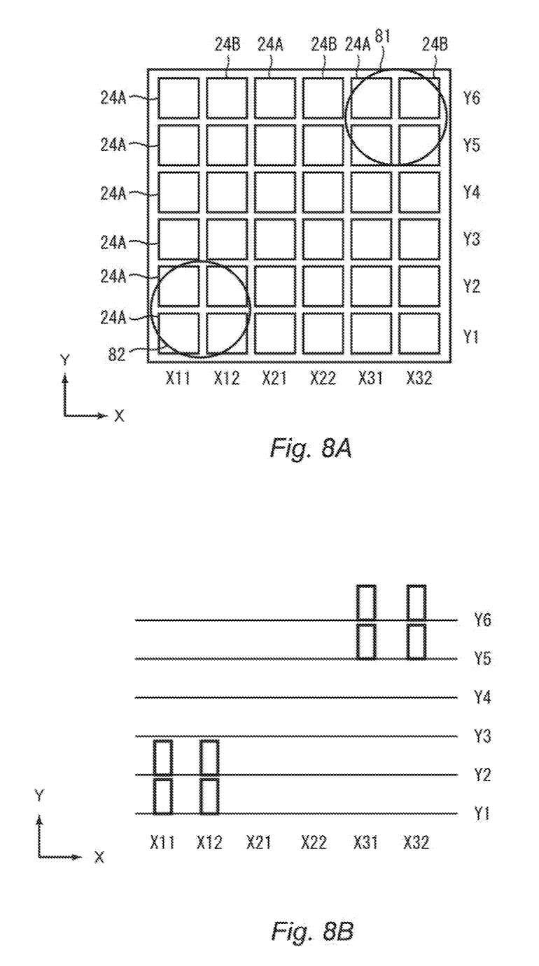

A specific example in which a touched position detected due to noise is removed based on touched positions detected by the mutual capacitance sensing and touched positions detected by the self-capacitance sensing, so that coordinates of the touched positions are detected, is described with reference to FIGS. 7A to 7B and 8A to 8B.

FIGS. 7A to 7B are diagrams illustrating exemplary amounts of changes in the charges in respective areas detected by the mutual capacitance sensing in a case where a certain area is touched. Further, FIGS. 8A and 8B are diagrams illustrating exemplary amounts of changes in the charges in respective areas detected by the self-capacitance sensing in a case where the same area as that in FIG. 7A is touched. In FIGS. 7A and 8A, electrodes (24A, 24B) in 6 rows×6 columns, that is, 36 electrodes, are illustrated. In other words, the electrode pairs 20 are in 6 rows×3 columns (see FIG. 7A), that is, 18 pairs. Further, areas 71, 72 illustrated in FIG. 7A (areas 81, 82 illustrated in FIG. 8A) are touched areas.

In FIG. 7B, the coordinates on the X axis and the Y axis indicate the position of the electrode pair 20 corresponding to the position of the electrode pair 20 illustrated in FIG. 7A, and the coordinate on the Z axis illustrates the amount of change in the charges. The amount of change in the charges indicated by the Z axis is indicated with 16 levels of 0 to 15.

In FIG. 8B, the amount of change in the charges corresponding to coordinates on the X axis and the Y axis illustrated in FIG. 8A are illustrated by a histogram. As described above, as compared with the resolution of the A/D conversion in the mutual capacitance sensing, the resolution of the A/D conversion in the self-capacitance sensing is lower. The amount of change in the charges, therefore, is also detected as a value of a lower resolution.

As described above, in the mutual capacitance sensing, in a case where the amount of change in the charges after calibration exceeds a predetermined threshold value, the electrode pair 20 concerned is determined as the electrode pair 20 at the touched position. Here, it is assumed that an area with the amount of change in the charges of 5 or more is detected as a touch area. In the example illustrated in FIG. 7B, therefore, the positions of the electrode pairs 20 at the coordinates of (X1, Y1), (X1, Y2), (X1, Y6), (X3, Y5), and (X3, Y6) are detected as touched areas.

On the other hand, even in the self-capacitance sensing, in a case where an increase in the calibrated electrostatic capacitance exceeds a predetermined threshold value, the electrodes 24A, 24B concerned are decided to be the electrodes 24A, 24B at the touched position. In the example illustrated in FIG. 8B, the positions of the electrodes 24A at the coordinates of (X11, Y1), (X11, Y2), (X31, Y5), and (X31, Y6), and the electrodes 24B at the coordinates of (X12, Y1), (X12, Y2), (X32, Y5), and (X32, Y6) are detected as touched areas.

Among the touched positions detected by the mutual capacitance sensing, the CPU 30 determines that the touched positions that do not coincide with the touched positions detected by the self-capacitance sensing are touched positions detected due to noise. Among the touched positions detected by the mutual capacitance sensing illustrated in FIG. 7B, the touched position (X1, Y6), which does not coincide with any one of the touched positions detected by the self-capacitance sensing illustrated in FIG. 88B, is determined to be the touched position detected due to noise, and is removed. The positions of the electrode pairs 20 at the coordinates of (X1, Y1), (X1, Y2), (X1, Y6), (X3, Y5), and (X3, Y6), detected by the mutual capacitance sensing, are therefore determined to be the touch areas.

The present invention is not limited to the above-described embodiment.

### DESCRIPTION OF REFERENCE NUMERALS

10 . . . touch panel
14A . . . pad,
16 . . . controller
18 . . . substrate
20 . . . electrode pair
22 . . . lead-out line
22A . . . lead-out line
22B . . . lead-out line
24A . . . electrode
24B . . . electrode
30 . . . CPU

1. A touch panel comprising:
a substrate;
a plurality of electrodes provided on the substrate;
a control unit that detects a touched position on the substrate; and
a plurality of lead-out lines that electrically connect the control unit and the electrodes,
wherein at least a part of the lead-out lines is arranged in an area on the substrate where a touched position can be detected, and
the control unit performs self-capacitance sensing for transmitting a signal to each of the electrodes thereby detecting a touched position, and mutual capacitance sensing for transmitting a signal to a plurality of pairs of electrodes, each pair being composed of two of the electrodes, thereby detecting a touched position, so as to detect a touched position based on the touched position detected by the self-capacitance sensing and the touched position detected by the mutual capacitance sensing.

2. The touch panel according to claim 1,
wherein the control unit detects the touched position, by removing, among the touched positions detected by the mutual capacitance sensing, a touched position that does not coincide with the touched position detected by the self-capacitance sensing.

3. The touch panel according to claim 1, further comprising:
a terminal unit that is electrically connected with the lead-out lines and the control unit, and is arranged closer to one of ends in the predetermined direction on the substrate than the electrodes are,
wherein, regarding the widths of the lead-out lines, the lead-out line connected with the electrode arranged at a position farther from the terminal unit has a greater width.

4. The touch panel according to claim 1,
wherein the control unit includes a circuit for performing the self-capacitance sensing, and performs the mutual capacitance sensing by using the circuit.
